(19) United States
(12) Patent Application Publication
(10) Pub. No.: US 2003/0142769 A1
(43) Pub. Date: Jul. 31, 2003

(54) Channel estimator a pipelined interfence cancellation apparatus

(76) Inventor: Leo Rademacher, Holzkirchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/275,299

(22) PCT Filed: Apr. 30, 2001
(86) PCT No.: PCT/EP01/04869

(30) Foreign Application Priority Data
May 3, 2000 (GB) 0010546.0

(51) Int. Cl. H04B 1/10

(52) U.S. Cl. 375/350; 375/148

(57) ABSTRACT

A known pipeline interference cancellation apparatus comprises a plurality of channel estimators. The channel estimates produced are filtered in order to reduce the effects of noise. However, in order to avoid the loss of symbols from weaker users, further filtering is required. The present invention simplifies the above described filtering processes by providing channel estimate and means (516) for generating a signal indicative of the accuracy of the channel estimate. An adaptive channel estimation unit (520) is provided to adapt coefficients of the channel estimation means (500)

The present invention relates to a channel estimator for a pipelined interference cancellation apparatus of the type used to cancel interference from multiple users in a Code Division Multiple Access (CDMA) communications receiver, for example, a Wideband-CDMA (W-CDMA) cellular telecommunications system.

In a spread spectrum radio communications system, baseband information from each user is combined with a spreading code specific to the user in order to yield corresponding wideband signals resembling noise. At a spread spectrum receiver, a signal is received which corresponds to a superposition of all the signals of all the users. In order to extract the baseband information of a given user from the received signal, the signal is combined with a respective de-spreading code corresponding to the spreading code of the given user. Symbols represented by the de-spread signal are subsequently detected by means of a known detection process employed by a detector.

However, components of the signal corresponding to users other than the given user constitute multiple access interference. Consequently, de-spread signals used by the detector contain multiple access interference components which reduce the efficiency of the detection process. It is therefore known to employ a parallel interference cancellation architecture, whereby approximations of interfering multiple access components are used to generate an improved estimate of the received signal corresponding to the given user. The parallel interference cancellation architecture employs channel estimation techniques to estimate the characteristics of the radio link, or channel, in order to generate as accurate models of the interfering multiple access components as possible.

“Parallel Interference Cancellation in Multiuser CDMA Channel” by M. Latva-aho and J. Lilleberg (Wireless Personal Communications 7, pages 171 to 195, 1998) describes a parallel interference cancellation architecture employing a pipelined architecture, whereby a de-spread signal corresponding to a stream of symbols is processed on a symbol-by-symbol basis, as opposed to on a blockwise basis. As a result of using the pipelined architecture, it is possible to feed back channel estimates from later stages of the parallel interference cancellation architecture to earlier stages of the parallel interference cancellation architecture, thereby providing improved channel estimation for the earlier stages. By providing improved channel estimation at the earlier stages, channel estimates subsequent to the earlier stages (and the final estimate of the symbols prior to detection) are improved.

In the above described architecture, channel estimation comprises multiplying a de-spread signal from a bank of matched filters with a complex conjugate of detected signals in order to generate an estimate of filter coefficients of a transversal filter representative of the channel (hereinafter referred to as “channel filter coefficients”). Subsequently, the estimates of the filter coefficients are further filtered by an adaptive channel estimation filter. The further filtering of the estimates of the filter coefficients was found necessary by the authors of the above document in order to avoid loss of timing from users corresponding to signals having poor signal to noise ratios. However, such a channel estimation technique has a high “overhead” in terms of processing power.

It is therefore an object of the present invention to obviate, or at least mitigate, the above described disadvantage associated with channel estimation for parallel interference cancellation architectures.

According to the present invention there is a channel estimator for a stage of a pipelined interference cancellation apparatus comprising channel estimation means for generating a channel estimate and means for generating a signal indicative of the accuracy of the channel estimate, wherein an adaptive channel estimation unit is arranged to directly adapt coefficients of the channel estimation means in response to the signal indicative of the accuracy of the channel estimate.

Preferably, the channel estimation means is a filter. More preferably, the filter is a transversal filter.

Preferably, the means for generating a signal indicative of the accuracy of the channel estimate is arranged to generate the signal indicative of the accuracy of the channel estimate in response to a vector of remodulated detected symbols and a vector of estimated interfering signals for all users in a system.

Preferably, the adaptive channel estimation unit adapts coefficients of the channel estimation means in response to the signal indicative of the accuracy of the channel estimate, a vector of channel coefficients received from a succeeding stage of the pipelined interference cancellation apparatus, a vector of detected symbols, and a vector of channel coefficients generated by the adaptive channel estimation unit.

Preferably, the adaptive channel estimation unit is employs a Least Mean Square (LMS) adaptive algorithm.

According to the present invention, there is also provided a pipelined interference cancellation apparatus comprising a plurality of channel estimators as set forth above.

Preferably, the pipelined interference cancellation apparatus further comprises a preceding stage and a succeeding stage, wherein a one symbol delay exists between the preceding stage and the succeeding stage for symbol detection and estimation of channel coefficients.

It is thus possible to provide a channel estimator for a pipelined interference cancellation apparatus requiring less processing power to estimate channel filter coefficients by reducing the number of taps which need to be adapted in order to provide accurate estimates of the channel filter coefficients.

At least one embodiment of the invention will now be described, by way of example, with reference to the accompanying drawings, in which:

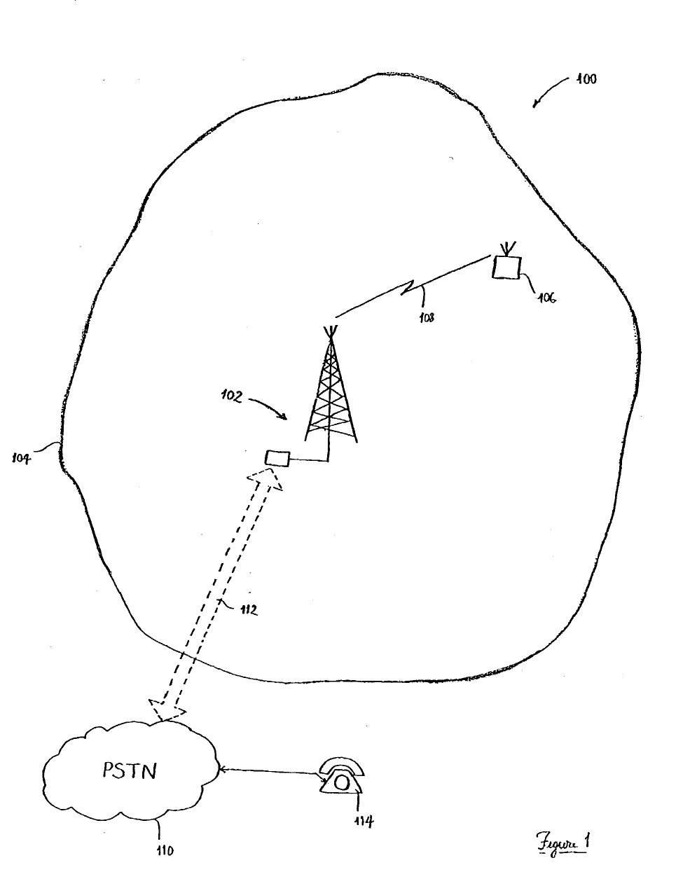

FIG. 1 is a schematic diagram of apparatus constituting a telecommunications link;

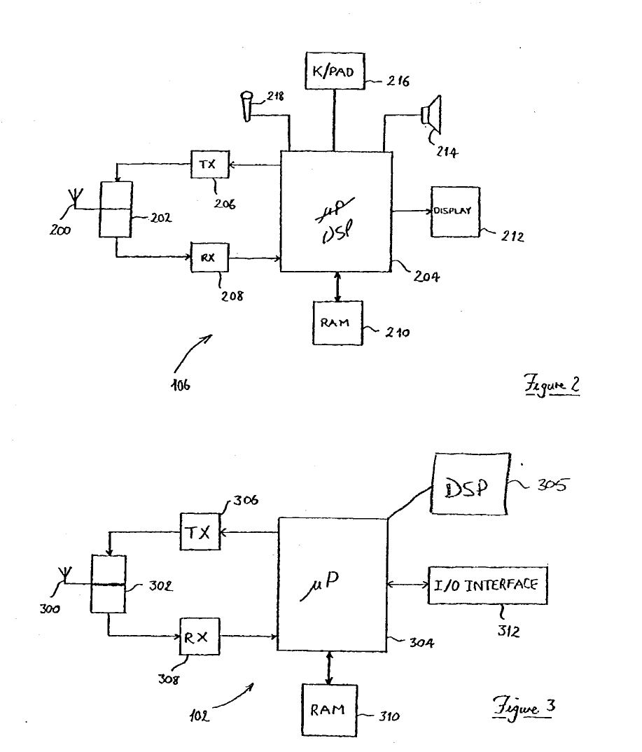

FIG. 2 is a schematic diagram of a mobile termiinal shown in FIG. 1;

FIG. 3 is a schematic diagram of a base station shown in FIG. 1;

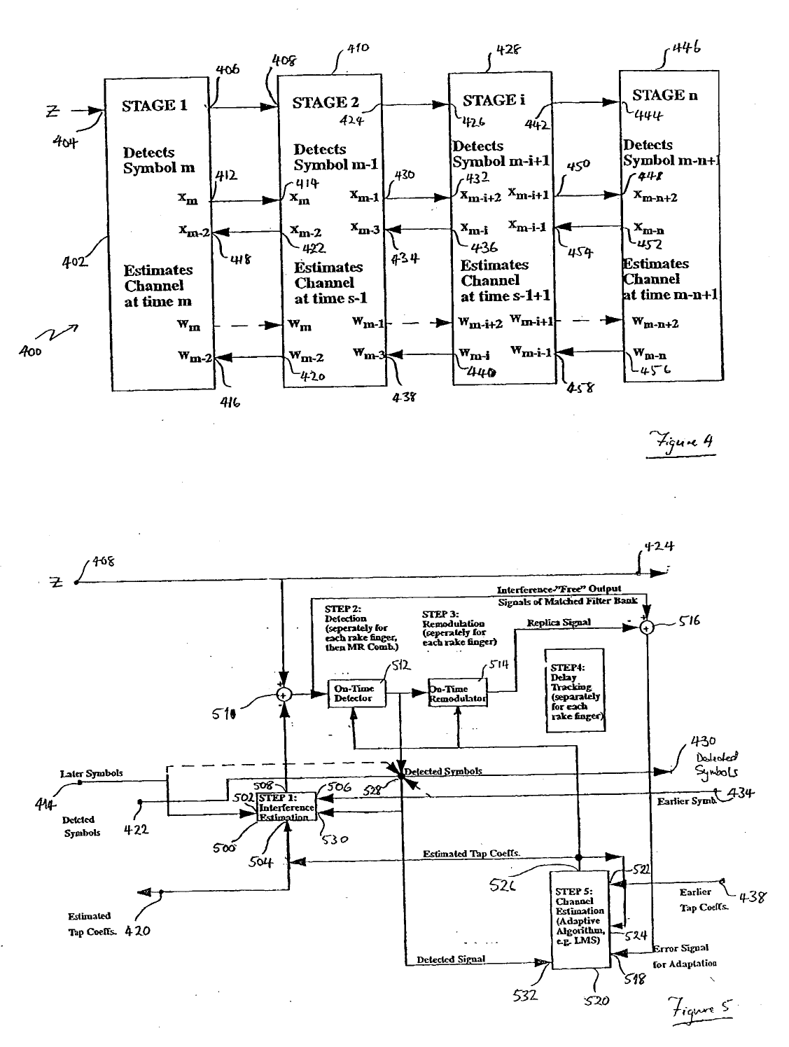

FIG. 4 is a schematic diagram of a pipelined interference cancellation architecture used by the mobile terminal and base station of FIGS. 2 and 3, and

FIG. 5 is a schematic diagram of a stage of the architecture of FIG. 4 constituting an embodiment of the invention.

Throughout the following description like parts will be identified by identical reference numerals.

In a cellular telecommunications network supported by, for example, a W-CDMA system 100 (FIG. 1), a base station 102 supports a geographical area, or cell 104, the base station 102 being in communication with a mobile user unit 106 via a radio frequency (RF) interface 108.

Communications between the base station 102 and, as an example only, a Public Switched Telecommunications Network 110 can be supported by any telecommunications architecture 112 known in the art. A fixed-line telephone 114 is also coupled to the PSTN 110.

It should be appreciated that although reference has been made above to particular types of terminals, other terminals can be used instead of the base station 102 or the mobile user unit 106, including, for example, fixed cellular terminals, or laptop computers/PDAs suitably adapted to function within the W-CDMA system 100. Similarly, although a fixed-line telephone 114 has been described above, other communications devices are envisaged, for example, a personal computer (PC) and a modem, or another mobile user unit operating in the W-CDMA system.

Referring to FIG. 2, the mobile user unit 106 comprises a terminal antenna 200 coupled to a terminal duplexer 202. Although, in this example, a single terminal antenna 200 has been described, it should be appreciated that an antenna array comprising more than one antenna coupled to an appropriate number of duplexing filters can be used.

A first terminal of the terminal duplexer 202 is coupled to a terminal Digital Signal Processor (DSP) 204 via a terminal transmitter chain 206. Similarly, a second terminal of the terminal duplexer 202 is coupled to the terminal DSP 204 via a terminal receiver chain 208. The terminal DSP 204 is coupled to a terminal Random Access Memory (RAM) 210, a display 212, for example, a liquid crystal display, a speaker unit 214, a keypad 216 and a microphone 218.

The base station 102 (FIG. 3) comprises a base station antenna 300 coupled to a base station duplexer 302. A first terminal of the base station duplexer 302 is coupled to a base station microprocessor 304 via a base station transmitter chain 306. Similarly, a second terminal of the base station duplexer 302 is coupled to the base station microprocessor 304 via a base station receiver chain 308. The base station microprocessor 304 is coupled to a base station DSP unit 305 and a base station RAM 310. Information is communicated to and from other parts of the cellular telecommunications network (not shown) by means of an I/O interface 312 coupled to the base station microprocessor 304.

For the purposes of simplicity of description and hence clarity, a pipelined interference cancellation architecture (FIG. 4) according to an embodiment of the invention will now be described in relation to the base station 102 only. However, it should be appreciated that the pipelined interference cancellation architecture can equally be employed in the mobile user unit 106.

The DSP unit 305 of the base station 102 is arranged to provide an n-stage interference cancellation unit 400. A first stage 402 comprises a first input terminal 404 to receive an input signal, z, corresponding to a signal received at the antenna 300 after conversion to baseband and analogue to digital conversion. A first output terminal 406 is provided in order to forward the input signal, z, to a first input terminal 408 of a second stage 410. The first stage 402 is arranged to detect an m^{th} vector of symbols, xₘ, and estimate a vector of coefficients, wₘ (hereinafter referred to as “filter coefficients”), of a transversal filter (not shown) representative of a channel through which signals propagate between the mobile user unit 106 and the base station 102.

The first stage 402 also comprises a second output terminal 412 for transferring the vector of m^{th} symbols, xₘ, to a second input terminal 414 of the second stage 410. A second input terminal 416 is provided for receiving estimates of filter coefficient vectors (in this example, wₘ₋₂) from the second stage 410 of the interference cancellation unit 400 via a first output terminal 420 of the second stage 410. Additionally, the first stage 402 has a third input terminal 418 for receiving estimated vectors of symbols (in this example, xₘ₋₂) from a second output terminal 422 of the second stage 410.

A third output terminal 424 of the second stage 410 is coupled a first input terminal 426 of an i^{th} stage 428 of the interference cancellation unit 400. A fourth output terminal 430 is coupled to a second input terminal 432 of the i^{th} stage 428 in order to receive a vector of (m—1)^{th} symbols, xₘ₋₁, detected by the second stage 410. A third input terminal 434 of the second stage 410 is coupled to a first output terminal 436 of the i^{th} stage 428 in order to receive a vector of (m−i)^{th} symbols, xₘ₋ᵢ, detected by the i^{th} stage 428. A fourth input terminal 438 of the second stage 410 is coupled to a second output terminal 440 of the i^{th} stage 428 in order to receive estimates of filter coefficient vectors (in this case, wₘ₋ᵢ) from the i^{th} stage 428.

A third output terminal 442 of the i^{th} stage 428 is coupled to a first input terminal 444 of an n^{th} stage 446 of the interference cancellation unit 400. A second input terminal 448 of the n^{th} stage 446 is coupled to a fourth output terminal 450 of the i^{th} stage 428 in order to receive a vector of symbols, xₘ₋ᵢ₊₁, detected by the i^{th} stage 428. A first output terminal 452 of the n^{th} stage is coupled to a third input terminal 454 of the i^{th} stage in order to receive a vector of symbols, xₘ₋ₙ, detected by the n^{th} stage 446. A second output terminal 456 of the n^{th} stage is coupled to a fourth input terminal 458 of the i^{th} stage in order to receive a vector of estimated channel coefficient, wₘ₋ₙ.

Referring to FIG. 5, for the purpose of simplicity of description, only the structure of the second stage 410 of the interference cancellation unit 400 will be described in more detail. However, each of the first, i^{th} and n^{th} stages of the interference cancellation unit 400 (FIG. 4) are configured in an analogous manner.

The second stage 410 comprises an interference estimation unit 500 including a transversal channel model filter representative of the channels of, interferers, a first, second and third input terminal 502, 504, 506 of the interference estimation unit 500 being coupled to the second input terminal 414, the first output terminal 420, and the third input terminal 434, respectively. A first output terminal 508 of the interference estimation unit 500 is coupled to a first input terminal of a first summation unit 510. A second input terminal of the first summation unit 510 is coupled to the first input terminal 408, an output terminal of the first summation unit 510 being coupled to a first input terminal of a detector unit 512 comprising a plurality of rake fingers. An output terminal of the detector unit 512 is coupled to a first input terminal of a remodulation unit 514. The structure of the detector unit 512 and the remodulatoion unit 514 are known in the art and so will not be described in any further detail.

An output terminal of the remodulation unit 514 is coupled a first terminal of a second summation unit 516, a second input terminal of the second summation unit 516 being coupled to the output terminal of the first summation unit 510. An output terminal of the second summation unit 516 is coupled to a first input terminal 518 of an adaptive channel estimation unit 520 in order to provide an error signal corresponding to the difference between an output signal at the output terminal of the first summation unit 510 and an output signal at the output terminal of the remodulation unit 514.

A second input terminal 522 and a third input terminal 524 of the adaptive channel estimation unit 520 are coupled to the forth input terminal 438 and the first output terminal 420, respectively, the input terminal 524 also being coupled to an output terminal 526 of the adaptive channel estimation unit 520. The output terminal 526 of the adaptive channel estimation unit 520 is also coupled to a second input terminal of the detector 512 and a second input terminal of the remodulation unit 514.

The output terminal of the detector unit 512 is coupled via a point of consolidation 528 to the second output terminal 422, the fourth output terminal 430, a fourth input terminal 530 of the interference estimation unit 500, and a fourth input terminal 532 of the adaptive channel model estimation unit 520.

In operation, the interference estimation unit 500 receives vectors of symbols via the second and third input terminals 414, 434 and the output terminal of the detection unit 512. Additionally, the interference estimation unit 500 receives a vector of channel estimate filter coefficients from the adaptive channel estimation unit 520 via the output terminal 526 and the input terminal 504, the adaptive channel estimation unit 520 receiving a vector of channel estimate filter coefficients from a succeeding stage via the input terminal 438. In response to the vectors of symbols received by the interference estimation unit 500, the interference estimation unit 500 generates a vector of estimated interference comprising joint remodulation of signals for all interfering users; the vector of estimated interference signals for all users is subtracted from the input signal, z, in order to remove signals corresponding to all interfering users, thereby leaving a signal of a given user of interest and noise. The result of the subtraction is used by the detection unit 512 to detect, in parallel, vectors of symbols corresponding to all users. The vector of symbols corresponding to all users is remodulated by the remodulation unit 514 using respective spreading codes associated with each of the users to yield a vector of remodulated signals. The vector of remodulated signals is subtracted from the vector constituting the subtraction of the vector of estimated interference from the input signal, z, to yield a vector of error signals indicative of the accuracy of the channel estimation performed by the adaptive channel estimation unit 520 used by the interference estimation unit 500.

In response to the vector of error signals described above, the vector of channel coefficients received via the fourth input terminal 438, the vector of detected symbols received from the detection unit 512 and the vector of channel coefficients fed back from the output terminal 526 of the adaptive channel estimation unit 520, the adaptive channel estimation unit 520 generates a vector of improved channel coefficients using any appropriate adaptive algorithm known in the art, for example, a Least Mean Square (LMS) algorithm.

Using the LMS algorithm, the vector of improved channel coefficient for an s^{th} stage , wₛ, is given by the following equation:

$${w}_{s}^{( m )} = {w}_{s}^{( m - 1 )} + {μ}_{s} ( {\sum }_{i = - D}^{D} {X}_{s}^{( m + i ) ′} {R}_{s}^{( m , m + i ) ′} ) e \qquad ( 1 )$$

where:

m is a symbol number;

s is a stage;

D is a channel delay or delay span of a channel impulse response;

w is the vector of improved tap/channel coefficients;

X is a convolution matrix of symbols;

e is an error signal vector;

R is a symbol correlation matrix between succeeding symbols, and

is an adaptation step size.

Although not specifically shown in FIG. 5, it should be understood that a one-symbol delay exists between each stage.

1. A channel estimator for a stage of a pipelined interference cancellation apparatus comprising channel estimation means for generating a channel estimate and means for generating a signal indicative of the accuracy of the channel estimate, wherein an adaptive channel estimation unit is arranged to directly adapt coefficients of the channel estimation means in response to the signal indicative of the accuracy of the channel estimate.

2. A channel estimator as claimed in claim 1, wherein the channel estimation means is a filter.

3. A channel estimator as claimed in claim 2, wherein the filter is a transversal filter.

4. A channel estimator as claimed in claim 1, wherein the means for generating a signal indicative of the accuracy of the channel estimate is arranged to generate the signal indicative of the accuracy of the channel estimate in response to a vector of remodulated detected symbols and a vector of estimated interfering signals for all users in a system.

5. A channel estimator as claimed in claim 1, wherein the adaptive channel estimation unit adapts coefficients of the channel estimation means in response to the signal indicative of the accuracy of the channel estimate, a vector of channel coefficients received from a succeeding stage of the pipelined interference cancellation apparatus, a vector of detected symbols, and a vector of channel coefficients generated by the adaptive channel estimation unit.

6. A channel estimator as claimed in claim 1, wherein the adaptive channel estimation unit is employs a Least Mean Square (LMS) adaptive algorithm.

7. A pipelined interference cancellation apparatus comprising a plurality of channel estimators as claimed in any one of the preceding claims.

8. An apparatus as claimed in claim 7, further comprising a preceding stage and a succeeding stage, wherein a one symbol delay exists between the preceding stage and the succeeding stage for symbol detection and estimation of channel coefficients.

9. A channel estimator substantially as hereinbefore described with reference to FIGS. 1 to 5.
